(19) United States
(12) Patent Application Publication
(10) Pub. No.: US 2007/0022854 A1
(43) Pub. Date: Feb. 1, 2007

(54) Machine for the automatic recovery of paper and tube separated from cutting scraps into rolls of logs or the like

(76) Inventor: Giovanni Gambini, Pisa (IT)

Correspondence Address: HEDMAN & COSTIGAN P.C., 1185 AVENUE OF THE AMERICAS, NEW YORK, NY, 10036, US

(21) Appl. No.: 11/492,527

(22) Filed: Jul. 25, 2006

(30) Foreign Application Priority Data
Jul. 28, 2005 (IT) MI2005A 001466

(51) Int. Cl. B26D 7/00

(52) U.S. Cl. 83/167

(57) ABSTRACT

A machine dedicated to the recovery of paper, generally of pure cellulose and therefore of optimal quality which may be integrally reused in the same productive cycle, a different recovery from that of the cardboard composing the core of the source roll which does not permit the reuse of the paper around it. Indeed, here the trimming rolls are recovered coming from the cutting of rolls for domestic or sanitary use. The recovery occurs after having arranged the rolls with the axis vertical, operating the insertion in the rolls of a guide bar which, with appropriate actuators, cuts them along the generatrix of the roll, maintaining the tube on the bar and allowing the paper to fall and then suctioning it and sending it to recovery, separately from the tube which remains gripped on the bar.

The present invention refers to a machine intended to separate but above all recover the pure cellulose paper contained in the trimming rolls or selvage of the cutting of paper reels in the production for domestic or sanitary use.

At the present state of the art, devices do not exist which may safely operate a separation between paper and cardboard inner tube of logs or the like of toilet paper and/or paper towels for domestic use. Such difficulty arises from the fact that there are intrinsic diversities of the tube, various diameters and various lengths, very often always different of these rolls, which are none other than trimmings or side discards or remains of a precise cutting work from an actual log or roll of sufficiently constant diameter. These trimmings, also called selvages, may be of two or three sizes, but of uncertain length, the reason for which until today it has been preferred to work these remnants by hand, given the considerable cost of the remnant of cellulose-rich white paper which may be reinserted in the actual production of new material.

Object of the present invention is therefore that of resolving the problems mentioned related to the recovery of both the paper and the cardboard of any size and length, since they are deriving from an end or trimming cutting operation.

These objects are achieved by realising a machine as described in the description and in the claims attached to the present description.

It is therefore noted how a machine of the invention, in addition to operating the separation and separate recovery of paper and core, executes a series of complementary preparation operations for the actual working. Indeed, during the precise cutting operation of the paper rolls for domestic or sanitary use, the cutter conveys the pieces produced to the final packaging machines, while the trimmings, of uncertain length but largely similar to each other, are separated and normally sent to the containers. According to the invention, the trimmings are conveyed with simple conveyor belts or the like to the principal conveyor of the present machine.

The first conveyor, in addition to moving the present rolls, has a simple sorter composed of an adjustable-height belt transverse to the conveyor, placed on a surface at a height slightly greater than the length of the roll in order to permit the free passage of the vertical axis rolls, and laterally move and therefore direct the superimposed or horizontal axis rolls, even knocking them over.

Once arranged with axis perpendicular to the conveyor belt, by means of movable and fixed lateral guides, the rolls are conveyed, as in a flat funnel on two parallel and centred belts in line with two parallel and vertical roller conveyors; once this course is terminated, which also operates by accumulation, two flat bands operated by actuators, generally pneumatics, at the precise command of a position reader of the roll make the trimming roll precipitate vertically, laterally and simultaneously coming off. In the fall, an “L”-shaped centering and guide pin with well-matched corner is inserted into the hole of the cardboard core, until the roll reaches a movable abutment which at the appropriate moment sends it toward the longitudinal cutting blade.

The cutter is composed of a blade arranged vertically on the upper horizontal generatrix of the previously mentioned centering pin of the trimming roll, therefore both the blade and a belt parallel to such pin bring the roll hinged into linear feed on the mentioned bar. At this point there is the separation of the paper wrapped around the core and the cardboard of the core: indeed, the cardboard, while cut, remains rolled up on the bar and will be pushed outside the machine, while the pure cellulose paper, just cut, opens up and even if slightly held by the belt falls downward. In such fall, the paper is taken by an appropriate suction pneumatic conveyor system and is sent once again to production or temporary stockpile.

Thus a completely automatic cycle is realized by the cutting machine of rolls for domestic use or the like, up until the recovery of the paper and its possible reuse, also directed if required.

It is evident that the ordering devices described here may also be substituted with other analogous devices while the cutting and recovery zone certainly remains as described or in any case subject to simple and unimportant modifications.

In the attached drawings, the various details of the machine are shown in an exemplifying and not limiting embodiment, in order to highlight the characteristics and advantages of a machine according to the invention.

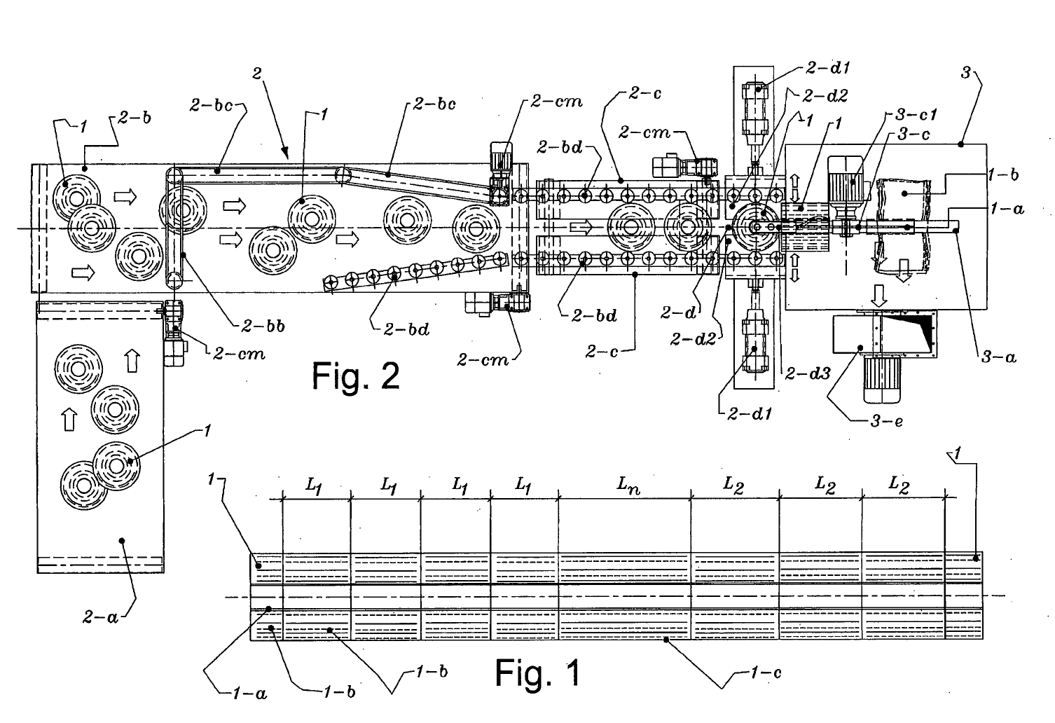

FIG. 1 is a section view of a log or long roll,

FIG. 2 is a plan view from above of a machine for the recovery of paper according to the invention,

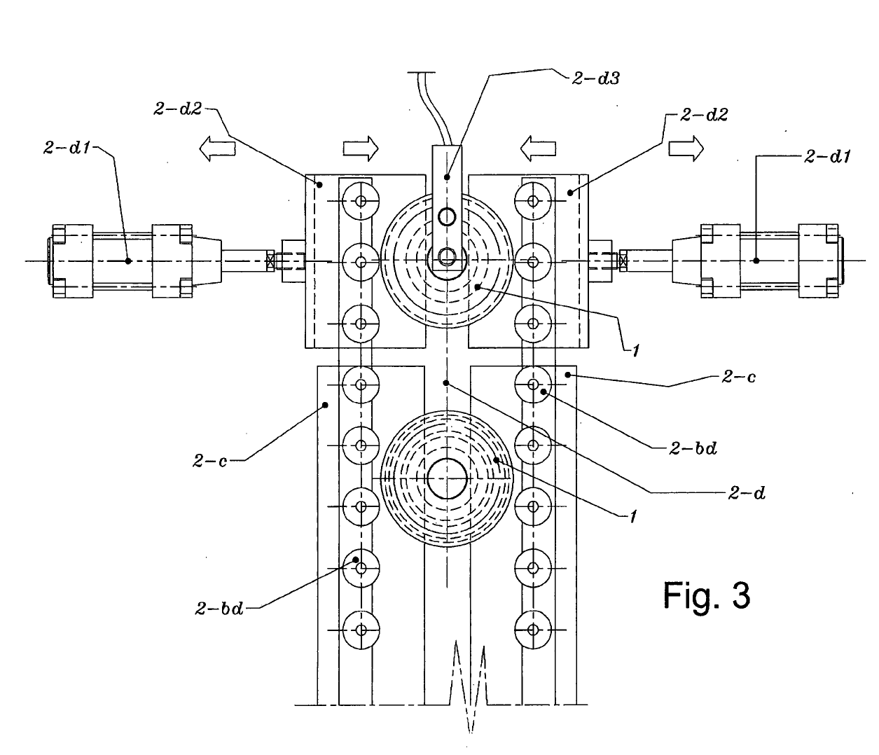

FIG. 3 is a plan view of an enlarged detail of FIG. 2 in a feeding zone of a single trimming roll or discard roll to a cutting zone,

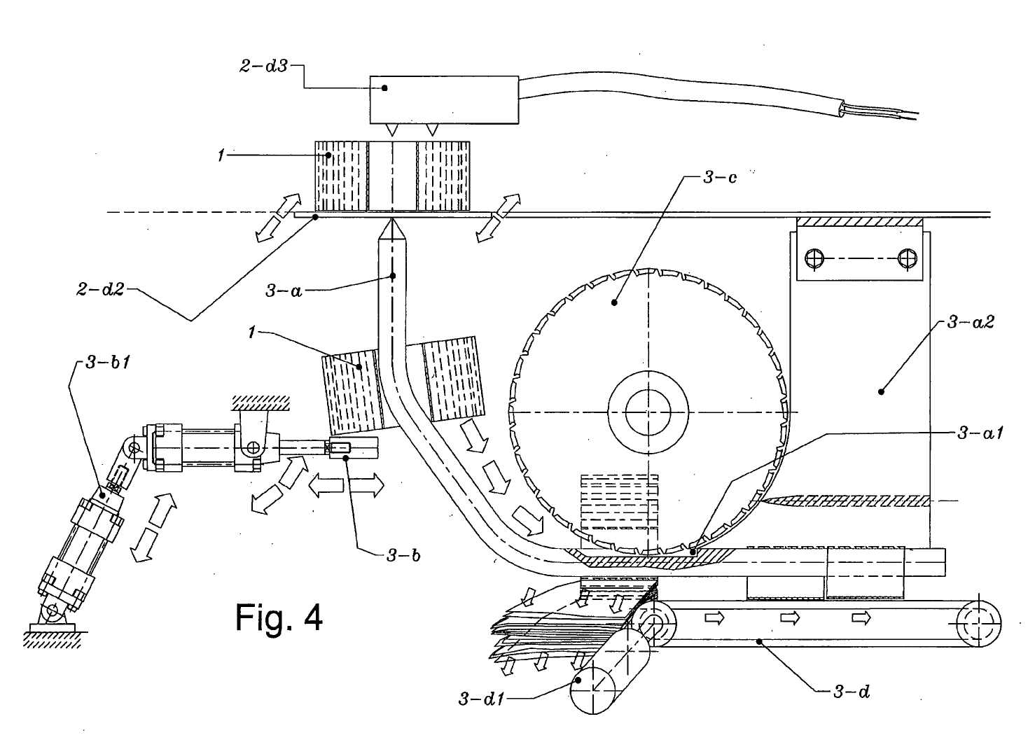

FIG. 4 is side elevation view, partially sectioned, of an enlarged detail of the zone of recovery and cutting of a trimming roll or discard roll,

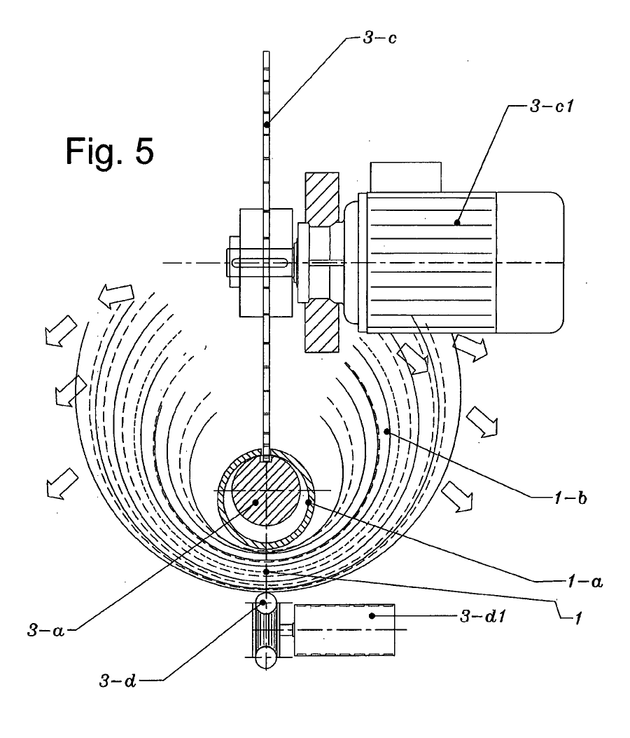

FIG. 5 is a front view, partially sectioned, at 90° with respect to FIG. 4.

In particular, meanings are attributed to the numbers and numbers with letters, which recall the various elements and groups, as reported here below:
with 1, a beginning or end scrap or trimming is indicated, or discard roll or the like composed of a paper zone, generally pure cellulose intended for domestic or sanitary use and for this reason usually of good or optimal quality, wrapped around a cardboard tube of low quality and cost;
with 1-a, a cardboard tube is indicated, normally used for wrapping paper of domestic or sanitary use; usually it is composed of a series of helically wrapped layers to form the mentioned tube with characteristics of strength and lightness;
with 1-b, paper is indicated for domestic or sanitary use, obtained by the overlapping of several preformed layers or other methods in use to produce it. Such paper is good-quality pure cellulose, is very often of first use and therefore valuable;
with 1-c, or L1, L2 . . . LN, the parts of a log or long roll, cut into various sizes, is produced of standard lengths depending on the production machines and then cut into small rolls, whose length is indicated here (L1, L2, etc.), for the mentioned domestic and sanitary uses;
with 2, an entire machine is indicated for the recovery of the paper 1-b coming from the end rolls of the cut or selvages of the initial main roll, the machine in its entirely is equipped with various operating accessories;
with 2-a, a conveyor belt is indicated of the trimming rolls of the production/cutting machine of the rolls intended for sales;
with 2-b, a first conveyor belt is indicated, whose orientation and direction is according to the direction requested for the operations of recovery for which the machine 2 is intended; this belt, for the functions for which it is intended, has a considerable horizontal development, even if it is of limited length;
with 2-bb, a belt is indicated, usually but not necessarily of circular section, brought into movement by a generic motorization, provides to sort the rolls 1 which may surmount others on the belt 2-b, compelling them to have their cardboard tube axis vertical (as generic reference) or rather, both 1-a and 1-b are perpendicular to the belt;
with 2-bc, a belt analogous to 2-bb is indicated, which is arranged slightly lower, close to 2-b, in order to accompany/guide into aligned position 1 for the recovery operations;
with 2-bd, vertical axis idle rollers or similar items, but also belts, are indicated for the centering, with respect to the flat conveyor belt or belts of the various trimming rolls 1; they operate as conveyors and aligners of 1;
with 2-c, a pair of small belts is indicated, parallel to the final preceding section of the feed device of trimmings 1 to the cutting group, these belts cooperating with two lines of rollers 2-bd placed parallel and in a containing fashion operate the final preparation of the rolls 1 toward the movable loading surfaces of the recovery machine or group 3;
with 2-cm, the various motorisations of the belts are indicated, preferably but not necessarily of electromechanical nature;
with 2-d, a positioning and feeding zone is indicated of the scrap rolls 1 to the paper separation and recovery machine 3;
with 2-d1, a pair of linear actuators, generally pneumatic or others similar are indicated;
with 2-d2, a pair of horizontally movable surfaces are indicated, brought into translation by 2-d1; opening or spaced from each other, they allow 1 to fall since the cardboard 1-a is inserted in the cutting guide bar, operating as a trap door;
with 2-d3, a position and centering reader of the roll 1 is indicated of generally photoelectric nature, which may also be realized with other types of feeler pins such as pneumatic or electromechanical feeler pins.
with 3, a machine of cutting and opening of 1, and therefore of separation of 1-b from 1-a is indicated, with consequent recovery of the paper or cellulose wads.
with 3-a, a curved bar is indicated, obtained from a tube of an appropriate diameter in relation with tubes 1-a to be received; it has a well-matched or radiated L shape, in the point towards 2-d it is equipped with a clear centering cone in order to facilitate the insertion of 1-a;
with 3-a1, a track is indicated for the insertion of the cutting blade 3-c on 3-a;
with 3-a2, an appropriately sharp blade or knife support is indicated, placed in line with the blade 3-c in order to permit the passage of the cardboard 1-a with minimum friction and the connection of 3-a with the supporting structure of the machine in the zone indicated with 3;
with 3-b, a linear actuator, generally pneumatic, equipped with head cylinder for the one by one containment of the scraps 1 in the guided descent of 1 towards the cutting blade, in order to obtain all of the cuts in a very precise manner, equivalent for all rolls;
with 3-c, a cutting blade of the roll 1 is indicated, with the cutting edge arranged along the generatrix of the bar 3-a in its horizontal section and also penetrates into the specific track 3-a1; said blade, for the cutting of paper and cardboard, has serrated teeth which rotate in the same direction as the advancing direction of the tube 1-a;
with 3-c1, a motor for the rotation of 3-c is indicated; the rotation is quite fast in the case of paper and cardboard, and indeed said blade is generally directly coupled to an appropriate two-pole motor;
with 3-d, a motorised belt is indicated, which in its upper zone has same-direction motion as the roll 1; it has a distance from 3-a depending on the thickness/thicknesses of the trimming rolls to be cut, vertically containing and supporting 1, and facilitates the flaking off opening of 1-b and simultaneously increases the support of 1-a on 3-a;
with 3-d1, a motor is indicated for the advancing of 3-d by means of a pair of pulleys, a driving one on the starter, and a tensioning one on the belt.
with 3-e, a schematic suction structure of the paper 1-b cut in zone 3 is indicated, while 1-a remains clinging to the tube 3-a until it moves outside the machine, which subsequently expels it;

Passing now to the details of the figures, in the attached FIGS. 1-5 it is quite easy to understand both the field of application and the operation of the present machine.

FIG. 1 shows a reel 1-c of paper already rolled up together, which is cut into different lengths depending on the final use, longer as for example L2 if intended for domestic use or in shorter rolls such as for example L1 for sanitary use.

The fact remains that in spite of how 1-c is cut, at the two ends two rolls 1 are produced, shorter than the others, called trimmings or selvages in jargon, also composed of cellulose paper 1-b rolled on low-quality cardboard 1-a which obviously cannot be readmitted in the preparatory cycle of the cellulose layer since it would ruin the mixture used to make high quality paper. FIG. 2 shows a general plan view of the machine and the various conveyors-sorters of the trimming rolls 1. Starting from the left and following the arrows and the rolls 1, one may observe the sequence both of the course and the operations which along the way from the left to the right are carried out on 1 itself.

The belt 2-a is placed here for exemplary use in order to indicate a generic origin from a machine of a previous process, in this case the cutting, which unloads here the various pieces 1 which are sent in bulk onto 2-b, the second belt, usually but not necessarily slightly ascending, where various trimming rolls may already have their axis vertical or else horizontal, or they may even be lying on other rolls and therefore slanting with respect to the conveyor 2-b. A movable belt 2-bb of an appropriate height, moving the rolls with its own motion, causes them to be arranged with axis perpendicular to the belt, passing therefore under 2-bb, and move toward the positioning zone 2-d for the insertion on the cutter 3; the operation of groups 2 and 3 will be more clearly explained in FIGS. 3, 4 and 5; exiting, finally, on the right side with respect to the advancing of the rolls a generic suction group is indicated which takes away the cellulose paper just cut in the cutting group 3.

The feed system of the rolls to the cutter represented in FIG. 3 will now be examined in detail, together with the cutting itself together with the various particular details necessary for its operation.

Indeed, FIG. 3 shows the pair of vertical rollers 2-bd, inside of which two trimming rolls 1 are represented, the first still on belts 2-c and in particular the higher one which rests on the two surfaces or bands 2-d2 which may extend from and close toward the centre by means of 2-d1, opening as soon as the position reader 2-d3 gives 1 permission to pass into the cutting zone 3.

The zone and operation characteristics of 3 are highlighted in FIG. 4, where to the left, under the position reader 2-d3, the roll 1 is situated; when the management system gives its permission, together with 2-d3, the bands 2-d2 open and 1 is inserted on the “L”-folded pin 3-a and stops on the ledge of the actuator 3-b, which provides, returning and accompanying 1 with 3-b1, to send 1 itself by controlled fall under the blade 3-c, which has the cutting region inserted within the “L”-folded tubular pin for a secure cut and also to permit the sliding-advancing of the tubes 1-a on 3-a.

With the cutting of all of the paper 1, along the generatrix of the cylinder constituting the roll, the paper 1-b itself tends immediately to open up or stretch out, leaving the tube 1-a, which instead proceeds, advancing towards the exit, still enclosed on 3-a although cut and pushed ahead by the tubes (and rolls) arriving on the cutter but also driven towards the exit by the rotation direction of the blade 3-c.

In order to completely ensure the advancing motion of the rolls to the cutting under 3-c and with central guide 1-a, a belt 3-d was positioned, motorised by the starter of any power origin 3-d1; the circular section but also flat belt exerts a light pressure on the paper 1 and simultaneously moving itself in the same direction as 1 and 1-a favours its advancement toward the end of 3-a, which is supported, behind the blade 3-c, by a sharpened support, like a knife, to allow the passage of 1-a in the cut zone without obstacles or difficulties.

It should also be said that upon leaving the blade 3-c, which operates the cutting, the paper 1-b due to its own lightness and minor stiffness opens and separates and may be easily recovered by a pneumatic conveyor, usually composed of a simple suction of a use-specific fan and then sent either to the recovery containers or directly to the mixture preparation zone.

FIG. 5 shows the final cutting zone in section, with 3-d in support of 1, 1-b and 1-a which remains “clinging” to 3-a, sustained by 3-a2 while 1-b opens as just described.

It is obvious that simple modifications of technical-contructive type do not modify the mode of operation of the present machine, which inherently keeps the tube or core on 3-a while it lets the pure cellulose paper fall and be separately recovered.

Thus one understands how according to the invention, a machine is realized which is intended to separate but above all recover the pure cellulose paper contained in the trimming or selvage rolls of the cutting of reels of paper for the production for domestic or sanitary use, separating it in a secure manner from the tube contained in the centre, which is called the core. This core is made of rather low-quality cardboard, thus it is not possible to reuse it together with the paper, and furthermore there also exist many sizes of these trimming rolls, with diverse diameter and length.

The present machine makes use of an ordering system of these rolls and therefore, with the axis placed vertically, causes the rolls to descend one by one, inserting a guide bar at the centre of the tube hole which leads the rolls toward a cutting system along the generatrix of the roll cylinder, operating now with the roll axis horizontal, and containing it slightly from below, and one obtains, once core and paper are cut, always along the generatrix, that the paper falls and the core remains supported on the above mentioned guide bar, until it moves outside the machine itself, permitting the recovery of the valuable or cellulose paper with a normal pneumatic conveyor system.

Thus the new and inventive technical solutions of the invention are quite evident, as are its advantages.

1. Machine for the automatic recovery of paper and tube separated from cutting scraps into rolls of logs or the like characterised in that it comprises a system of ordering beginning and/or end trimmings or little rolls deriving from the cutting into rolls of logs or the like, each comprising cellulose paper with cardboard core intended for domestic or sanitary use, which arranges said vertical-axis trimmings, one after the other, towards an insertion device on a drop cutting group comprising a shaped vertical pin which receives the rolls and sends them towards a longitudinal cutting blade, along the generatrix of the trimming cylinder, said blade being inserted in a slot of the pin, in order to execute a half-roll cut of paper and cardboard core, there being foreseen a pneumatic suction-conveyor system for said cut paper, said trimming being supported below and externally during the cutting by a belt which advances in the same direction as the cutting.

2. Machine for the automatic recovery of paper and tube separated from cutting scraps into rolls of logs or the like characterised in that it is essentially realized by a system or method, generally mechanical, of ordering of the cylinders of cellulose paper with cardboard core, coming from the trimmings of the paper reels intended for domestic or sanitary use, which arranges them with axis vertical to the ground and one after the other until they reach an insertion device in the specific drop cutting group, where a vertical pin, square-shaped with matched corner, collects them one by one, cooperating with a guided insertion device towards a longitudinal cutting blade along the generatrix of the roll cylinder, blade inserted in a slot of the pin, which executes said half-roll cut including the cardboard core which due to its shape and stiffness remains on the pin, integral with the structure, while the cellulose paper cut along the generatrix is wholly opened and is easily drawn by a pneumatic suction-conveyor system, the roll being moreover sustained during the cutting by a belt which advances in the same direction as the cutting and pin, which in addition to sustaining the cores cut along the generatrix conducts them to an unloading place separated from the cellulose.

3. Machine according to claim 1, characterised in that it possesses a system of ordering and sorting the scrap rolls or selvage coming from the trimming of the reels and arranges them along the vertical axis.

4. Machine according to claim 2, characterised in that it possesses a system of ordering and sorting the scrap rolls or selvage coming from the trimming of the reels and arranges them along the vertical axis.

5. Machine according to claim 1, characterised in that it is provided with a group of insertion to the cutting of the scrap rolls equipped with horizontally and vertically movable surfaces or bands in order to permit the ordered forwarding to the cutting along the generatrix.

6. Machine according to claim 2, characterised in that it is provided with a group of insertion to the cutting of the scrap rolls equipped with horizontally and vertically movable surfaces or bands in order to permit the ordered forwarding to the cutting along the generatrix.

7. Machine according to claim 1, characterised in that it possesses a cutting group with “L” pin connected and sustained by a vertical blade connected to the machine frame, the pin intended to guide the rolls toward the cutting and to sustain the cut cores or tubes until they reach the unloading zone outside the machine.

8. Machine according to claim 2, characterised in that it possesses a cutting group with “L” pin connected and sustained by a vertical blade connected to the machine frame, the pin intended to guide the rolls toward the cutting and to sustain the cut cores or tubes until they reach the unloading zone outside the machine.

9. Machine according to claim 1, characterised in that it possesses a pneumatic guide group of the scrap roll composed by one or two actuators which follow its descent towards the blade.

10. Machine according to claim 2, characterised in that it possesses a pneumatic guide group of the scrap roll composed by one or two actuators which follow its descent towards the blade.

11. Machine according to claim 7, characterised in that it possesses a blade with the edge inserted within the guide and support of the scrap rolls advancing to the cutting, blade which proceeds to the simultaneous cutting of both the pure cellulose paper and support tube or core of said rolls.

12. Machine according to claim 8, characterised in that it possesses a blade with the edge inserted within the guide and support of the scrap rolls advancing to the cutting, blade which proceeds to the simultaneous cutting of both the pure cellulose paper and support tube or core of said rolls.

13. Machine according to claim 1, characterised in that it possesses at its outlet a pneumatic suction or conveyor system for the withdrawing and separation of the pure cellulose paper from the cardboard cylindrical core placed at the centre.

14. Machine according to claim 2, characterised in that it possesses at its outlet a pneumatic suction or conveyor system for the withdrawing and separation of the pure cellulose paper from the cardboard cylindrical core placed at the centre.

15. Machine according to claim 1, characterised in that it possesses two separate outlets, one for the pure cellulose paper and one for the cardboard tubes or cores directly on the cutting guide pin.

16. Machine according to claim 2, characterised in that it possesses two separate outlets, one for the pure cellulose paper and one for the cardboard tubes or cores directly on the cutting guide pin.
